(19) United States
(12) Patent Application Publication
(10) Pub. No.: US 2008/0238633 A1
(43) Pub. Date: Oct. 2, 2008

(54) Computer System with ID Tag

(76) Inventor: Franz Siebert, Augsburg (DE)

Correspondence Address: SLATER & MATSIL, L.L.P., 17950 PRESTON RD, SUITE 1000, DALLAS, TX, 75252-5793, US

(21) Appl. No.: 12/058,115

(22) Filed: Mar. 28, 2008

(30) Foreign Application Priority Data
Mar. 29, 2007 (DE) 10 2007 015 234.7

(51) Int. Cl. H04Q 5/22; G06F 11/00

(52) U.S. Cl. 340/10.51; 714/1

(57) ABSTRACT

A computer system (1) includes a housing. An RFID tag (4) can be placed as a rating plate on the housing of the computer system (1).

This application claims priority to German Patent Application 10 2007 015 234.7, which was filed Mar. 29, 2007 and is incorporated herein by reference.

### TECHNICAL FIELD

The invention concerns a computer system with a housing.

### BACKGROUND

Computer systems, for example, servers, are mostly mounted in a large number in a server rack. The configuration or the brand of the individual server can vary. In order to distinguish the servers from one another, they are provided with a serial number during production. Usually, the serial number is printed as a number chain or a barcode on an adhesive label and is stuck on a housing of the server.

The front side of the housing of the server is freely accessible if it is mounted in the server rack. The housing of the server is usually 1 to 3 inches high. Usually, CD-ROM or DVD drives or hard disk drives or diskette drives, I/O slots or connections of the server are arranged on the front side. Therefore, little or no space is available on the front side for the adhesive label. The adhesive label, therefore, is stuck on a side other than the front side of the server. To read the serial number, the server must be turned off and be dismantled from the server rack.

### SUMMARY OF THE INVENTION

In one aspect, the invention provides a computer system whose serial number, system components, system status, or other data specific for the computer system are recorded and further processed, simply and independently from the operating state of the computer system.

For example, a computer system with a housing can have be an RFID tag integrated on the housing as a rating plate. The RFID tag has a storage unit. The computer system includes an interface device to conduct information from the computer system to the RFID tag and to store the transmitted data in the storage unit of the RFID tag. In the event of abnormal operation of the computer system, the transmitted data thereby contain error information emitted during the abnormal operation.

Specific data for the computer system are stored on the rating plate. For example, they are a serial number, hardware or software equipment in a delivery state or a connect load of the computer system. Likewise, with abnormal functioning of the computer system, error data of the computer system are recorded, which, for example, comprise data from the BIOS/error storage unit. Since these data are stored on the RFID tag, they can be recorded, for example, with a reading device by a user by simply reading the RFID tag and can be used both for inventory purposes and also to eliminate errors. The reading of the RFID tag can take place while the computer system is turned on or off or even if it is defective. The RFID tag can be a passive or an active RFID tag. The active RFID tag is provided with power, wherein the power supply preferably occurs via the computer system.

In a preferred embodiment, the RFID tag is located on a front shield of the housing. If the computer system is built into a server rack, then the front shield is freely accessible. In this way, the RFID tag is easily accessible and can be simply read. The RFID tag requires very little space, for example, a few millimeters and thus can be adapted to the size of the remaining space on the front shield. A large number of specific data of the computer system can be stored on the RFID tag and can be recorded simply with the reading device.

In another advantageous embodiment, the computer system has a slide-in unit to hold the RFID tag. Advantageously, the slide-in unit is located in a narrow slit on the front shield and can be inserted into or extracted from the housing. The slide-in unit is favorably made of plastic. The slide-in unit is suitable, in particular, for RFID tags with large dimensions. The size of the RFID tag also depends, for example, on the range which the RFID tag is supposed to have.

In another advantageous embodiment, the housing of the computer system has a recess in the area of the RFID tag. A metal surface on which the RFID tag is located can have a disturbing effect for reading of the RFID tag. The recess in the area of the RFID tag can prevent such a possible disturbance during reading of the RFID tag.

Advantageously, the housing of the computer system in an area of the RFID tag is made of plastic. In this way, a possible disturbance during reading of the RFID tag is prevented.

In another advantageous embodiment, the computer system in the area of the RFID tag has a metal shielding, at a distance from the tag, within the computer system. In this way, an electromagnetic compatibility (EMV) of the computer system is guaranteed.

Advantageously, data from the manufacture of the computer system are stored on the RFID tag as a rating plate. The RFID tag can, for example, be described with data from the delivery state of the computer system, immediately after its final assembly. Also, a buyer of the computer system has these data immediately available on the RFID tag, without the computer system having to be turned on or unpacked.

In another advantageous embodiment, the computer system has a device for inductive inscription of the RFID tag. The RFID tag is inscribed by the device via an inductive coupling. The advantage is to be found in the fact that the energy supply for the RFID tag can be carried out without a cable, via an HF field of the device. The RFID tag can be inscribed via the device for inductive inscription and also with a reading/writing device from outside the computer system.

Additional details and developments of the invention are also disclosed herein.

### BRIEF DESCRIPTION OF THE DRAWINGS

The invention is explained in more detail, below, with exemplified embodiments and with the aid of the drawings, wherein:

FIG. 1 illustrates a first exemplified embodiment of a computer system with an

FIG. 2 illustrates a second exemplified embodiment of the computer system with the RFID tag, which can be inscribed by a reading/writing device;

FIG. 3 illustrates a third exemplified embodiment of the computer system with an interface device and the RFID tag;

FIG. 4 illustrates a fourth exemplified embodiment of the computer system with an interface device and the RFID tag, which can be inscribed by the reading/writing device; and

FIG. 5 illustrates a fifth exemplified embodiment of the computer system with a device for inductive inscription of the RFID tag.

The following reference symbols can be used in conjunction with the drawings: 1 Computer system 2 Drive 3 Connection 4 RFID tag 5 Reading/writing device 6 Interface device 7 Hardware components 8 BIOS storage unit 9 Device for inductive inscription 10 Front shield

### DETAILED DESCRIPTION OF ILLUSTRATIVE EMBODIMENTS

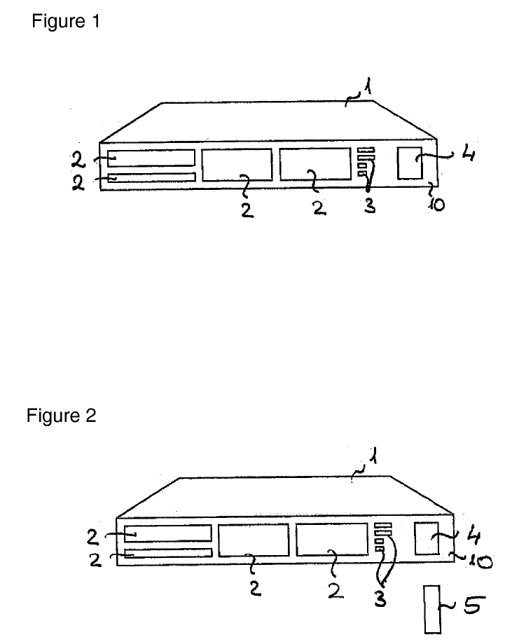

FIG. 1 shows, in a first exemplified embodiment, a computer system 1. The computer system 1 has a front shield 10, a large number of drives 2, connections 3, and an RFID tag 4. For better understanding of the drawing, the RFID tag 4 is represented greatly enlarged.

The drives 2 are located in slide-in units of the computer system 1 and are accessible via recesses in the front shield 10 of the computer system 1. The drives 2 are, for example, a CD-ROM drive, a DVD drive, a diskette drive, or hard disk drives. The connections 3 are provided, for example, designed as a PCI interface or to connect to a computer network.

The computer system 1 is, for example, a Primergy RX100 from Fujitsu Siemens and has a height of one height unit, also known as U1.

The RFID tag 4 is designed as a rating plate and is located on the front shield 10. During the manufacture of the computer system 1, specific data of the computer system 1 are stored on the RFID tag 4. For example, the data can include a manufacturing date, a serial number, a device type, and a hardware configuration. The hardware equipment comprises, for example, a type and output of a processor of the computer system 1, a storage unit, and if present, the type and number of expansion cards.

These specific data of the computer system 1 can be recorded simply with a reading device, also called a scanner. The RFID tag 4, as a rating plate, is unchangeable in this exemplified embodiment. The RFID tag 4 is designed as a passive RFID tag 4 with a range of approximately 1 cm.

Depending on the design and type of construction, it is possible to place RFID tags 4 with a greater range on the front shield 10. It is possible to place an RFID tag 4 with greater dimensions in a slide-in unit made of plastic in the computer system 1. To read or inscribe, the slide-in unit is pulled out of the computer housing.

In the area of the RFID tag 4, a housing of the computer system 1 is made of plastic, so that a reading of the RFID tag 4 is possible without disturbances and is not impaired by a metal surface.

The housing of the computer system 1 has, in the area of the RFID tag 1 and at a distance from said tag, a metal shielding within the computer system 1. Thus, a disturbance-free reading or inscribing of the RFID tag 4 is made possible and at the same time, the EMV of the computer system 1 is guaranteed.

In the housing of the computer system 1, it is possible to provide a recess in the area of the RFID tag 4, so that a housing made of metal does not impair the reading of the RFID tag 4. Since the RFID tag 4 preferably has small dimensions, the recess is small and does not impair the EMV of the computer system 1.

In a second exemplified embodiment, FIG. 2 shows the computer system with the RFID tag 4, which can be inscribed by a reading/writing device 5.

In this exemplified embodiment, the RFID tag 4 has an inscribable transponder. For example, the storage unit of the RFID tag 4 is then an EEPROM (“electrically erasable programmable memory”) or a FRAM (“ferromagnetic random access memory”) with a storage capacity of 64 bytes to 32 kbytes. The RFID tag 4 or rather its storage unit is inscribed via an inductive coupling of the reading/writing device 5 in this exemplified embodiment. The RFID tag 4 is also supplied with power by the reading/writing device 5 via the inductive coupling.

The RFID tag 4, for example, is edited with the reading/writing device 5 and an inventory number is stored in the storage unit of the RFID tag 4. The inventory number is given by a user. It is also possible to store a number for the computer system 1 or a comment from the user on the RFID tag 4 or rather in its storage unit.

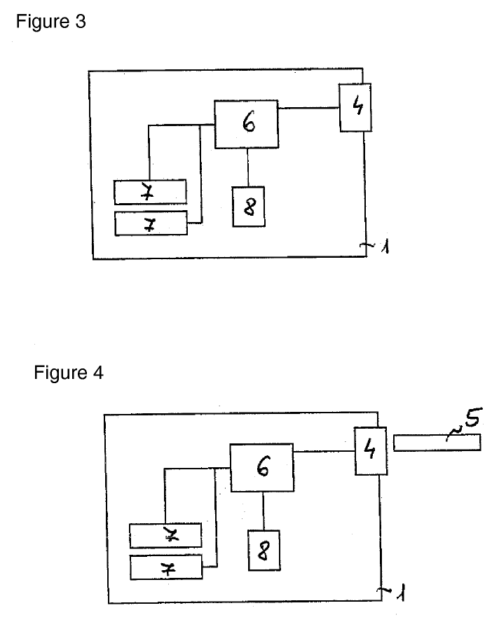

In a third exemplified embodiment, FIG. 3 shows a simplified drawing of the computer system 1 with an interface device 6 and the RFID tag 4. The RFID tag 4 can be inscribed from within the computer system and can be read from outside the computer system 1. This is shown in FIG. 3 with a schematic RFID tag 4, which is found at least in part outside the computer system 1.

The computer system 1 has hardware components 7 and a BIOS storage unit 8 for the BIOS of the computer system 1. Other electronic components present in the computer system 1 are not depicted in the drawing.

The interface device 6 is connected to the hardware components 7 and the BIOS storage unit 8 and has an electrical connection to the RFID tag 4. Via the interface device 6, it is possible to record the actual hardware configuration of the computer system 1, send it on to the RFID tag 4, and store it in the storage unit of the RFID tag 4. This is carried out with a so-called RFID writing via the interface device 6. Data for the software, system information, or the operating system are also stored in the storage unit of the RFID tag 4 via the interface device 6. These specific data can be stored, for example, at the start or also during the operation of the computer system 1, on the RFID tag.

With an abnormal operation of the computer system 1, error reports or, if necessary, information regarding the elimination of errors are stored in the BIOS storage unit 8 or in an error storage unit of the computer system 1. The error reports and the information regarding their elimination are stored via the interface device 6 in the storage unit of the RFID tag 4.

If the computer system 1 is defective and, for example, can not be turned on, it is nevertheless possible to read the error reports from the RFID tag 4 and to perhaps eliminate the errors. Even with a power breakdown, the specific data of the computer system 1 remain stored on the RFID tag 4.

When inscribing the RFID tag 4, energy, on the one hand, is needed, and, on the other hand, the cables via which the electrical connection between the interface device 6 and the RFID tag 4 is brought about emit radiation. With such a wire-bound interface device 6, care must be taken that the EMV of the computer system 1 is guaranteed.

It is possible to use passive or active RFID tags 4. Active RFID tags 4 must be provided with power. An RFID tag 4 with a battery as the power supply is not suitable since the battery is a finite supply of power and after a certain time has to be replaced. The power supply for the RFID tag 4 therefore takes place via the computer system 1.

In a fourth exemplified embodiment, FIG. 4 shows the computer system 1 with the interface device 6 and the RFID tag 4, which can be inscribed by the reading/writing device 5. In this exemplified embodiment, the RFID tag 4 can be inscribed and/or read by the computer system 1 and from the outside via the reading/writing device 5. It is possible to store data with the reading/writing device 5 in the storage units of the RFID tag 4 and to read them for further processing in the computer system 1 via the interface device 6.

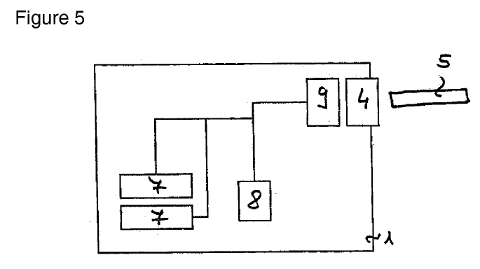

In a fifth exemplified embodiment, FIG. 5 shows the computer system 1, wherein the computer system 1 has a device 9 for inductive inscription of the RFID tag 4.

The RFID tag 4 is inscribed wirelessly from the computer system 1 via the device 9. The RFID tag 4 has the inscribable transponder with, for example, the EEPROM.

The advantage of the device 9 for inductive inscription of the RFID tag 4 is the inductive coupling between the RFID tag 4 and the device 9, so that a wireless interface is formed for inscription of the RFID tag 4. Moreover, a wireless power supply is thus also present for the RFID tag 4.

For inscription of the RFID tag 4 with specific data of the computer system 1, such as the hardware configuration, the software configuration, or perhaps, error reports from the BIOS storage unit 8, high transmitting power is needed. In order to shield the computer system 1 against this radiation, the inscription of the RFID tag 4 should then take place if this is not critical for the computer system 1.

The RFID tag 4 is read with the reading/writing device 5. It is possible to store information in the storage unit of the RFID tag 4 via the reading/writing device 5 and to read it for further processing in the computer system 1 via the device 9.

Additional exemplified embodiments of the invention are not explained here in more detail, but are covered by the invention.

What is claimed is:

1. A computer system comprising:
a housing;
an RFID tag integrated on the housing of the computer system, wherein the RFID tag serves as a rating plate and has a storage unit;
an interface device communicatively coupled to the RFID tag such that information can be conducted from the computer system to the RFID tag and the information can be stored in the storage unit of the RFID tag, wherein the data contain error information sent during an abnormal operation of the computer system.

2. The computer system according to claim 1, wherein the storage unit on the RFID tag can be inscribed for inventorying the computer system via a reading/writing device from outside the computer system.

3. The computer system according to claim 1, wherein the data in the storage unit of the RFID tag can be read by a reading/writing device from outside the computer system.

4. The computer system according to claim 1, wherein the housing includes a front shield, the RFID tag being located on the front shield of the housing of the computer system.

5. The computer system according to claim 1, further a slide-in unit within the housing, the slide-in unit holding the RFID tag.

6. The computer system according to claim 1, wherein the housing of the computer system has a recess in an area of the RFID tag.

7. The computer system according to claim 1, wherein the housing of the computer system in an area of the RFID tag is made of a non-electrically conductive material.

8. The computer system according to claim 7, further comprising a metal shielding within the housing in the area of the RFID tag and spaced from the RFID tag.

9. The computer system according to claim 1, wherein the RFID tag includes data that was stored during manufacture of the computer system, the data are stored on the RFID tag as the rating plate.

10. The computer system according to claim 1, wherein the RFID tag has a power supply via the computer system.

11. The computer system according to claim 1, further comprising a device for inductive inscription of the RFID tag.

12. The computer system according to claim 11, wherein data from the computer system are stored on the storage unit of the RFID tag via the device.

13. The computer system according to claim 1, wherein the computer system is a server in a server rack.

14. A method of operating a computer system, the method comprising:
providing a computer system with a housing, wherein an RFID tag that includes a storage unit is integrated on the housing of the computer system;
communicating information from the computer system to the RFID tag;
storing the communicated information in the storage unit of the RFID tag; and
retrieving the stored information from outside the computer system.

15. The method according to claim 14, wherein retrieving the stored information comprises retrieving data containing error information sent during an abnormal operation of the computer system.

16. The method according to claim 14, further comprising writing information to the storage unit of the RFID tag from outside the computer system.

17. The method according to claim 16, wherein writing information comprises writing inventory information.

18. The method according to claim 14, further comprising retrieving rating plate data from the storage unit of the RFID tag

19. The method according to claim 18, wherein the rating plate data was stored during manufacture of the computer system.
